(19) United States
(12) Patent Application Publication
(10) Pub. No.: US 2026/0100637 A1
(43) Pub. Date: Apr. 9, 2026

(54) CONTROL DEVICE AND POWER CONVERTER

(71) Applicant: FUJI ELECTRIC CO., LTD., Kawasaki-shi (JP)

(72) Inventor: Sachio TAKANO, Hachioji-city (JP)

(73) Assignee: FUJI ELECTRIC CO., LTD., Kawasaki-shi (JP)

(21) Appl. No.: 19/342,342

(22) Filed: Sep. 26, 2025

(30) Foreign Application Priority Data
Oct. 9, 2024 (JP) 2024-177010

(51) Int. Cl. H02M 1/12; H02M 7/483; H02M 7/5395

(52) U.S. Cl. CPC H02M 1/123; H02M 7/483; H02M 7/5395

(57) ABSTRACT

A control device, having a virtual synchronous generator function, for controlling an inverter interconnected to a power system via a power transmission/distribution line. The control device includes: a first output unit outputting a first phase of an output voltage of the inverter based on the active power from the inverter, a first command value, and the virtual synchronous generator function; a second output unit outputting an amplitude of the output voltage based on the reactive power and a second command value; a phase correction value output unit outputting a phase correction value, based on the first command value and a circuit constant of the power transmission/distribution line; an addition unit outputting a second phase obtained by adding the phase correction value and the first phase; and a third output unit outputting a control signal to control the inverter, based on the amplitude of the output voltage and the second phase.

### CROSS-REFERENCE TO RELATED APPLICATIONS

The present application claims priority pursuant to 35 U.S.C. § 119 from Japanese patent application number 2024-177010 filed on Oct. 9, 2024, the entire disclosure of which is hereby incorporated by reference herein.

### BACKGROUND

### Technical Field

The present disclosure relates to a control device and a power converter.

### Description of the Related Art

Some power converters may have a function of a virtual synchronous generator (which may also be referred to as pseudo synchronous generator) (for example, see Japanese Patent Application Publication Nos. 2019-176584, 2021-13207, and 2024-60953).

Meanwhile, in a power converter having a function of a typical virtual synchronous generator, fluctuations occur in the power of an inverter when the command value of active power changes. When the power fluctuations are large, a step-out may occur, which may cause instability in a power system.

### SUMMARY

A first aspect of the present disclosure is a control device having a virtual synchronous generator function, the control device being configured to control an inverter interconnected to a power system via a power transmission/distribution line, the control device comprising: a first output unit configured to receive a first command value, and active power from the inverter, and output a first phase of an output voltage of the inverter based on the active power, the first command value, and the virtual synchronous generator function; a second output unit configured to receive a second command value, and reactive power from the inverter, and output an amplitude of the output voltage based on the reactive power and the second command value; a phase correction value output unit configured to receive the first command value, and output a phase correction value, based on the first command value and a circuit constant of the power transmission/distribution line between the inverter and the power system; an addition unit configured to output a second phase obtained by adding the phase correction value and the first phase; and a third output unit configured to output a control signal to control the inverter, based on the amplitude of the output voltage and the second phase.

A second aspect of the present disclosure is a power converter comprising: an inverter interconnected to a power system via a power transmission/distribution line; and a control device having a virtual synchronous generator function, the control device being configured to control the inverter, the control device including a first output unit configured to receive a first command value, and active power from the inverter, and output a first phase of an output voltage of the inverter based on the active power, the first command value, and the virtual synchronous generator function, a second output unit configured to receive a second command value, and reactive power from the inverter, and output an amplitude of the output voltage based on the reactive power and the second command value, a phase correction value output unit configured to receive the first command value, and output a phase correction value, based on the first command value and a circuit constant of the power transmission/distribution line between the inverter and the power system, an addition unit configured to output a second phase obtained by adding the phase correction value and the first phase, and a third output unit configured to output a control signal to control the inverter, based on the amplitude of the output voltage and the second phase.

### BRIEF DESCRIPTION OF THE DRAWINGS

FIG. 1 is a diagram illustrating an example of a power converter 10a.

FIG. 2 is a diagram to explain active power between a power converter 10a and a power system.

FIG. 3 is a diagram illustrating an example of a power converter 15.

FIG. 4 illustrates diagrams illustrating examples of active power and reactive power when the command value of active power is changed.

FIG. 5 illustrates diagrams illustrating examples of active power and reactive power when the command value of active power is changed.

FIG. 6 is a diagram illustrating an example of a power converter 10b.

### DETAILED DESCRIPTION

At least following matters will become apparent from the descriptions of the present description and the accompanying drawings. The same or equivalent constituent elements, members, and the like illustrated in the drawings are given the same reference numerals, and repetitive description is omitted as appropriate.

### Power Converter 10a

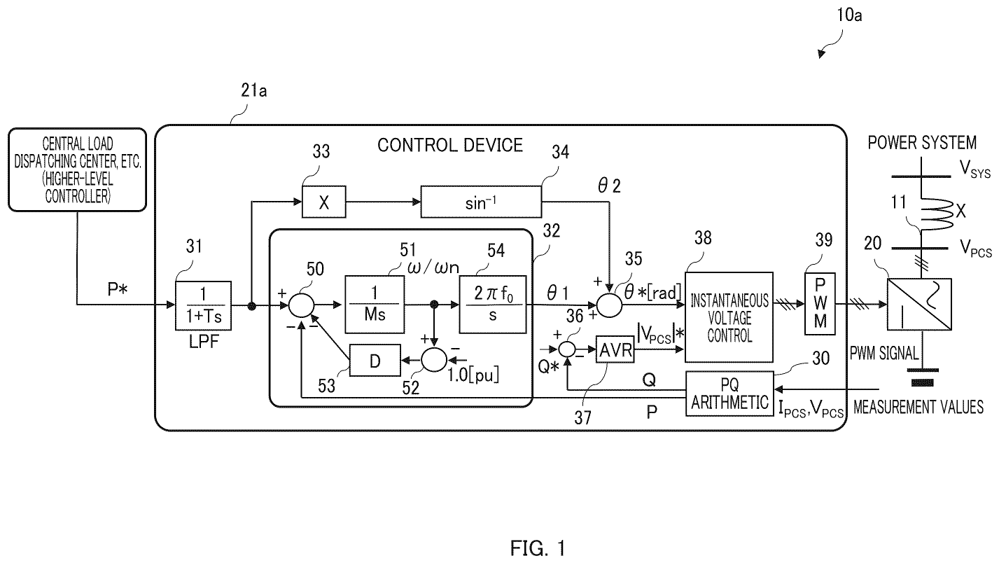

FIG. 1 is a diagram illustrating an example of a power converter 10a according to an embodiment of the present disclosure. The power converter 10a is a device that exchanges power with a power system, while being interconnected to the power system. The power converter 10a includes an inverter 20 and a control device 21a.

The inverter 20 is a device that exchanges alternating current (AC) power with the interconnected power system through a three-phase power transmission line 11, in response to a Pulse Width Modulation (PWM) signal. Note that the power transmission line 11 of an embodiment of the present disclosure includes transmission/distribution lines.

The control device 21a is a device that controls an output voltage VPCS of the inverter 20, in response to an instruction from a central load dispatching center (hereinafter referred to as “load dispatching center” or simply referred to as “CLDC”), a higher-level controller, or the like, the central load dispatching center monitoring the demand of the power system, and the like. Note that, in an embodiment of the present disclosure, the output voltage VPCS includes three-phase AC voltage respectively corresponding to the three-phase power transmission line 11, for example.

The control device 21a includes a PQ arithmetic unit 30, a low-pass filter (LPF) 31, a virtual synchronous power generation unit 32, a multiplication unit 33, an arithmetic unit 34, an addition units 35, 36, an automatic voltage regulator (AVR) 37, an instantaneous voltage control unit 38, and a PWM circuit 39. In the control device 21a, blocks other than the PWM circuit 39 are realized by, for example, a digital signal processor (DSP) not illustrated included in the control device 21a executing a predetermined program.

The PQ arithmetic unit 30 measures the output voltage VPCS and the output current IPCS from the inverter 20 at the position at which the inverter 20 and the power transmission line 11 are interconnected ((hereinafter referred to as position A), to thereby calculate active power P and reactive power Q from the measurement results.

The low-pass filter 31 removes noise and the like from the command value P* of the effective power P, and outputs a result to the virtual synchronous power generation unit 32 and the multiplication unit 33. Note here that the output from the low-pass filter 31 is also referred to as command value P*, for convenience.

The virtual synchronous power generation unit 32 is a function block that virtually simulates a synchronous generator (i.e., a block of a virtual synchronous generator function), and outputs a phase θ1 of the output voltage VPCS of the inverter 20 based on the command value P*. The virtual synchronous power generation unit 32 includes addition units 50, 52 and arithmetic units 51, 53, 54. Note that the virtual synchronous power generation unit 32 of an embodiment of the present disclosure corresponds to a “first output unit”, the phase θ1 corresponds to a “first phase”, and the command value P* corresponds to a “first command value”.

The addition unit 50 subtracts, from the command value P*, the active power P obtained by the PQ arithmetic unit 30 and the output from the arithmetic unit 53 (described later), and outputs the result of the subtraction to the arithmetic unit 51.

The arithmetic unit 51 multiplies the output from the addition unit 50 by a coefficient 1/M (described later), and then performs time integration from the time when the initial value has been provided to the current time. Here, “M” is a value indicating inertia the constant of the virtual synchronous generator. In an embodiment of the present disclosure, the integration result of the arithmetic unit 51 is a value obtained by converting the frequency ω of the output voltage VPCS of the power converter 10a into a unit of the nominal frequency ωn of the power system.

Here, the nominal frequency ωn of the power system is, for example, in Japan, a value obtained by multiplying 50 Hz by 2π in eastern Japan and a value obtained by multiplying 60 Hz by 2π in western Japan. Accordingly, when the frequency @ of the output voltage VPCS is equal to the nominal frequency, the value of ω/ωn [pu] reaches 1.0, which will be described in detail later. Thus, in this case, the addition unit 50 outputs a difference between the command value P* and the effective power P obtained by the PQ arithmetic unit 30.

The addition unit 52 outputs a value obtained by subtracting 1.0 from the value of ω/ωn, which is the output from the arithmetic unit 51. The arithmetic unit 53 multiplies the output from the addition unit 52 by a coefficient D, to thereby output a result. Here, “D” is a value indicating the damping constant of the virtual synchronous generator.

The arithmetic unit 54 multiplies w/on, which is the output from the arithmetic unit 51, by the nominal frequency ωn (=2πf0), and integrates a result. As a result, the arithmetic unit 54 outputs the phase θ1 of the output voltage VPCS of the power converter 10a. In other words, the arithmetic unit 54 calculates the phase θ1 for causing the active power P from the power converter 10a to be the command value P*, based on the active power P that is to be fed back.

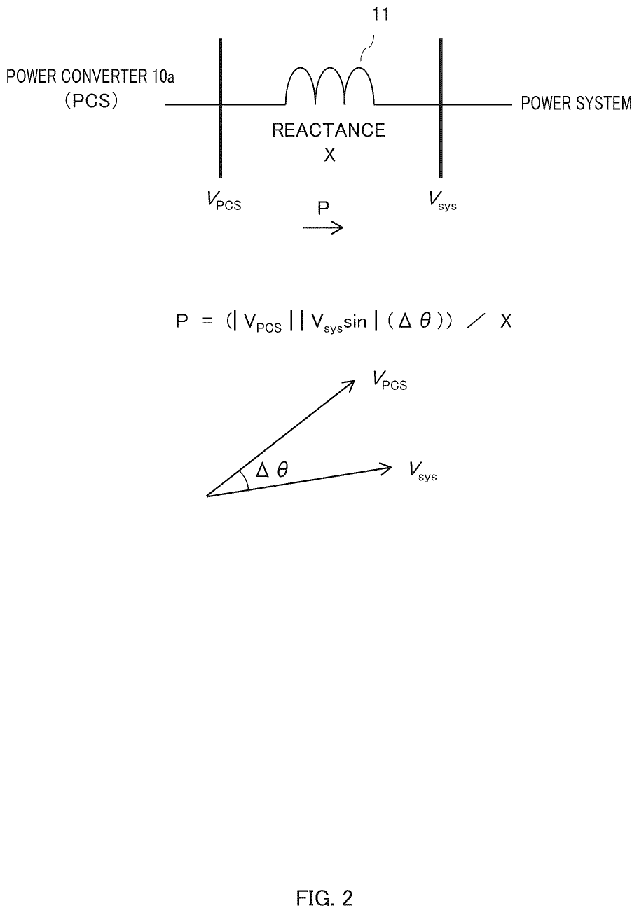

The multiplication unit 33 multiplies the command value P* of the active power P by a coefficient X, and the arithmetic unit 34 outputs the arcsine value of the result of the multiplication of the multiplication unit 33. Here, “X” is a value indicating the reactance of the power transmission line 11 between the power converter 10a and the power system as illustrated in FIG. 2. In the upper part of FIG. 2, the output voltage VPCS is given at the position A at which the power converter 10a and the power transmission line 11 are connected. Further, the system voltage VSYS of the system is given at a position B at which the power transmission line 11 and the power system are connected. Further, in an embodiment of the present disclosure, the reactance of the power transmission line 11 between the power converter 10a and the power system is used, however it only needs to be the “circuit constant” of the power transmission line 11 between the power converter 10a and the power system, such as the impedance (including not only the resistance of the power transmission line itself but also including the parasitic capacitance) of the power transmission line 11, and the like.

Further, the lower part of FIG. 2 illustrates a schematic diagram indicating the relationship between the active power P and the output voltage VPCS and system voltage VSYS each including information on the amplitude and phase. Here, the active power P from the power converter 10a is given as Expression (1).

$$P = ( \vert VPCS \vert \cdot \vert VSYS \vert \cdot sin ( Δ θ ) ) / X \qquad ( 1 )$$

In Expression (1), |VPCS| is the amplitude (magnitude) of the output voltage VPCS, |VSYS| is the amplitude (magnitude) of the system voltage VSYS, and Δθ is the phase difference between the output voltage VPCS and the system voltage VSYS. Further, X is the reactance of the power transmission line 11 described above.

In Expression (1), assuming that |VPCS| and |VSYS| are 1.0 [pu], which indicates the rating of each of them, Expression (1) results in Expression (2).

$$P \cdot X = sin ( Δ θ ) \qquad ( 2 )$$

Expression (3) can be obtained from Expression (2) as follows.

$$Δ θ = sin - 1 ( P \cdot X ) \qquad ( 3 )$$

Accordingly, for example, in order for the power converter 10a to output the active power P, the phase difference Δθ between the output voltage VPCS and the system voltage VSYS needs to satisfy the relationship of Expression (3).

The multiplication unit 33 in FIG. 1 multiplies the command value P* by the coefficient X, and the arithmetic unit 34 outputs the arcsine value of the result of the multiplication of the multiplication unit 33. Accordingly, the multiplication unit 33 and the arithmetic unit 34 calculate, based on the expression (3), the phase θ2 that is needed for the power converter 10a to output the command value P* as the active power P. The arcsine value corresponds to a “phase correction value”, and the multiplication unit 33 and the arithmetic unit 34 corresponds to a “phase correction value output unit”.

Here, the multiplication unit 33 and arithmetic unit 34 of an embodiment of the present disclosure output the phase θ2 of the output voltage VPCS for causing the active power P to be the command value P*, through a so-called feedforward path, without through a feedback path in FIG. 1 (path from the PQ arithmetic unit 30 to the virtual synchronous power generation unit 32). This enables the power converter 10a to immediately change the active power P when the command value P* changes, which will be described in detail later.

The addition unit 35 adds the phase θ1 from the virtual synchronous power generation unit 32 and the phase θ2 from the arithmetic unit 34, to thereby output the phase θ* which is the result of the addition. The addition unit 36 calculates the difference between the reactive power Q from the PQ arithmetic unit 30 and a command value Q* with respect to the reactive power Q. Note that the phase θ2 from the arithmetic unit 34 of an embodiment of the present disclosure corresponds to an “arcsine value”, and the phase θ* corresponds to a “second phase”.

The AVR 37 outputs the amplitude |VPCS*| of the output voltage VPCS of the power converter 10a, based on the difference between the reactive power Q and the command value Q*. Note that the command value Q* of an embodiment of the present disclosure corresponds to a “second command value”, and the AVR 37 corresponds to a “second output unit”.

The instantaneous voltage control unit 38 outputs, to the PWM circuit 39, an instruction to cause the instantaneous value of the three-phase output voltage of the power converter 10a to be the phase θ* and the amplitude |VPCS*|. As a result, the PWM circuit 39 outputs a PWM signal according to the above-described instruction, and thus the inverter 20 outputs the voltage VPCS whose instantaneous value has the phase θ* and the amplitude |VPCS*|. Note that the PWM circuit 39 and the instantaneous voltage control unit 38 of an embodiment of the present disclosure correspond to a “third output unit”, and the PWM signal corresponds to a “control signal”.

Here, a typical power converter to be compared in explaining an operation of the power converter 10a will be explained.

### Power Converter 15

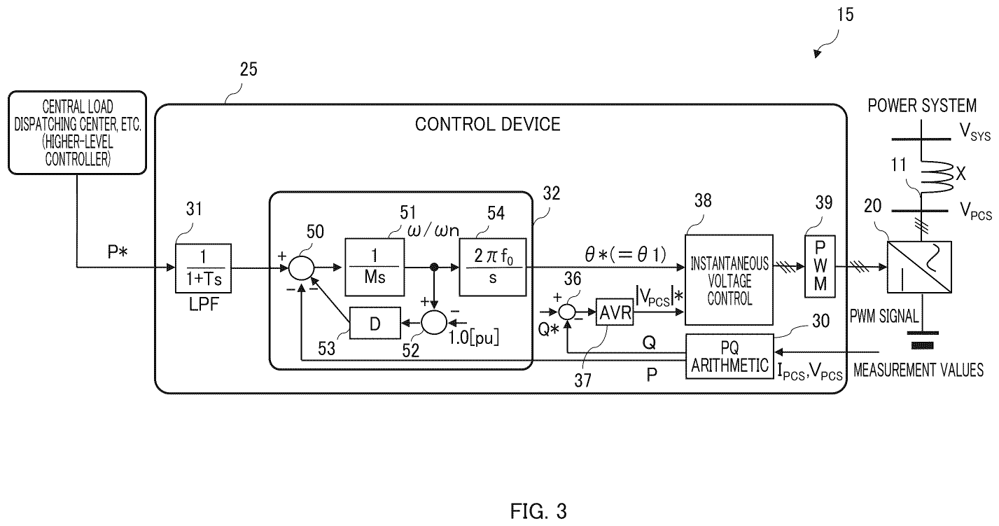

FIG. 3 is a diagram illustrating an example of a typical power converter 15. The power converter 15 includes the inverter 20 and a control device 25. The control device 25 includes the PQ arithmetic unit 30, the low-pass filter 31, the virtual synchronous power generation unit 32, the addition unit 36, the AVR 37, the instantaneous voltage control unit 38, and the PWM circuit 39.

The control device 25 in FIG. 3 has the same configuration as the control device 20a in FIG. 1 except for the multiplication unit 33, the arithmetic unit 34, and the addition unit 35. Accordingly, when the command value P* of the active power P changes, the control device 25 outputs the phase θ* (here, θ*=θ1) of the output voltage VPCS, based on the path of the feedback (path from the PQ arithmetic unit 30 to the virtual synchronous power generation unit 32).

### Operations of Power Converters 10a, 15

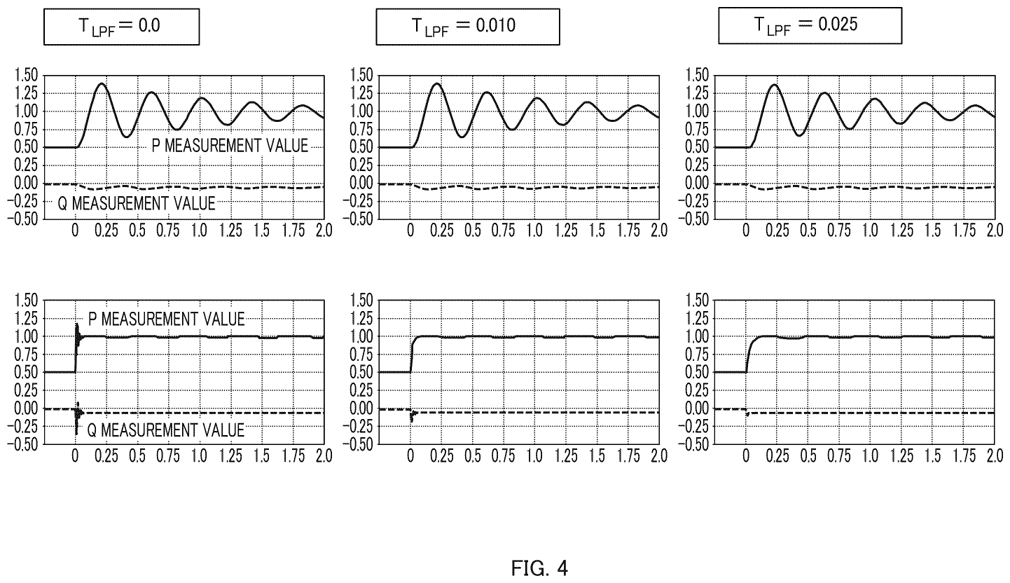

FIG. 4 illustrates waveform diagrams of the active power P and the reactive power Q of the power converters 10a, 15 when the command value P* of the active power P is increased from 0.5 [pu] to 1.0 [pu] at time t=0. Here, the active power P and the reactive power Q are respectively given a P measurement value (solid line) and a Q measurement value (dotted line). The upper part of FIG. 4 illustrates the active power P and the reactive power Q of the typical power converter 15, and the lower part of FIG. 4 illustrates the active power P and the reactive power Q of the power converter 10a in an embodiment of the present disclosure.

It is assumed here that the reactance X of the power transmission line 11 is 0.1 [pu], the inertia constant M is 5.0 [s], and the constant D is 100. The reactance X being 0.1 [pu] refers to that when the reactive power Q equivalent to 0.1 [pu] is supplied to the reactance X, the output voltage VPCS decreases by 0.1 [pu]. Further, in each of the upper and lower parts of FIG. 4, the low-pass filter 31 is a first-order lag filter having a time constant TLPF of 0.0, 0.010, and 0.025 from the left.

Here, at time t=0, the command value P* of the active power P is increased from 0.5 [pu] to 1.0 [pu]. As illustrated in the upper part of FIG. 4, in the power converter 15, after relatively large power fluctuations occur in the active power P, the active power P gradually converges to a target value (1.0 [pu]). On the other hand, as illustrated in the lower part of FIG. 4, in the power converter 10a, power oscillations hardly occur in the active power P, and the active power P immediately converges to the target value (1.0 [pu]).

As to the reactive power Q, in the power converter 15, some power fluctuations occur therein, however, in the power converter 10a, power fluctuations substantially do not occur therein.

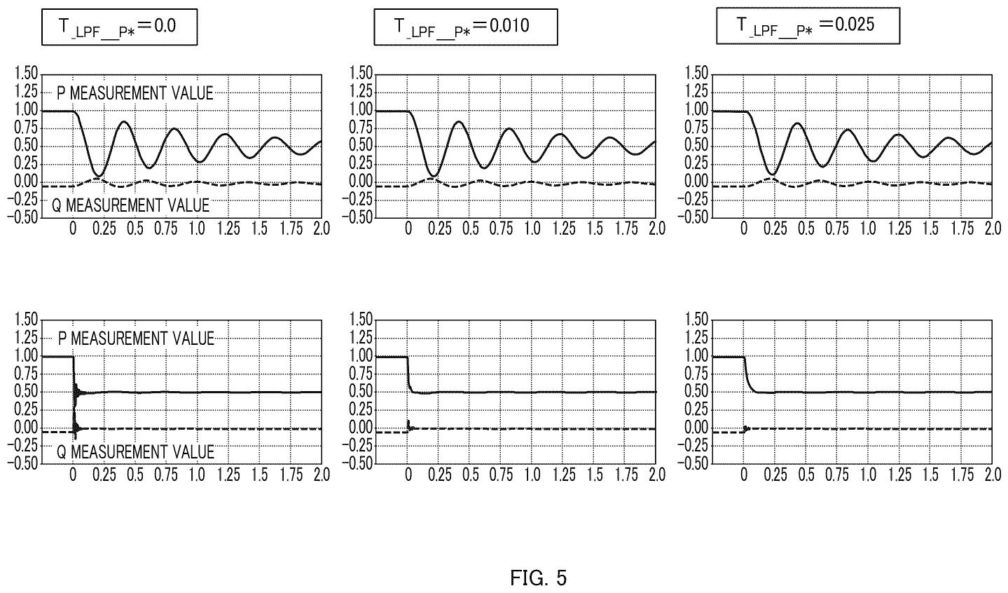

FIG. 5 illustrates waveform diagrams of the active power P and the reactive power Q of the power converters 10a, 15 when the command value P* of the active power P is reduced from 1.0 [pu] to 0.5 [pu] at time t=0. Here again, the active power P and the reactive power Q are given the P measurement value (solid line) and the Q measurement value (dotted line), respectively. The upper part of FIG. 5 illustrates the active power P and the reactive power Q of the typical power converter 15, and the lower part of FIG. 5 illustrates the active power P and the reactive power Q of the power converter 10a of an embodiment of the present disclosure.

In FIG. 5, the reactance X, the inertia constant M, the damping constant D, the time constant TLPF of the low-pass filter 31 are the same as those conditions described above. As illustrated in the upper part of FIG. 5, in the power converter 15, after a comparatively large power fluctuations occur in the active power P, the active power P gradually converges to a target value (0.5 [pu]). On the other hand, as illustrated in the lower part of FIG. 5, in the power converter 10a, power fluctuations substantially do not occur in the active power P, and the active power P immediately converges to the target value (0.5 [pu]).

As to the reactive power Q, in the power converter 15, some power fluctuations occur therein, however, in the power converter 10a, power fluctuations substantially do not occur therein.

As such, in the power converter 10a of an embodiment of the present disclosure, the multiplication unit 33 and the arithmetic unit 34 output the phase θ2 of the output voltage VPCS for causing the active power P to be the command value P*, through the so-called feedforward path, without through the feedback path (path from the PQ arithmetic unit 30 to the virtual synchronous power generation unit 32). As a result, when the command value P* of the active power P changes, the power converter 10a can immediately cause the active power P to be the command value P*. As a result, with the use of the power converter 10a of an embodiment of the present disclosure, it is possible to suppress power oscillations of each of the active power P and the reactive power Q, and thus also suppress the occurrence of a step-out.

### Power Converter 10b (Another Embodiment)

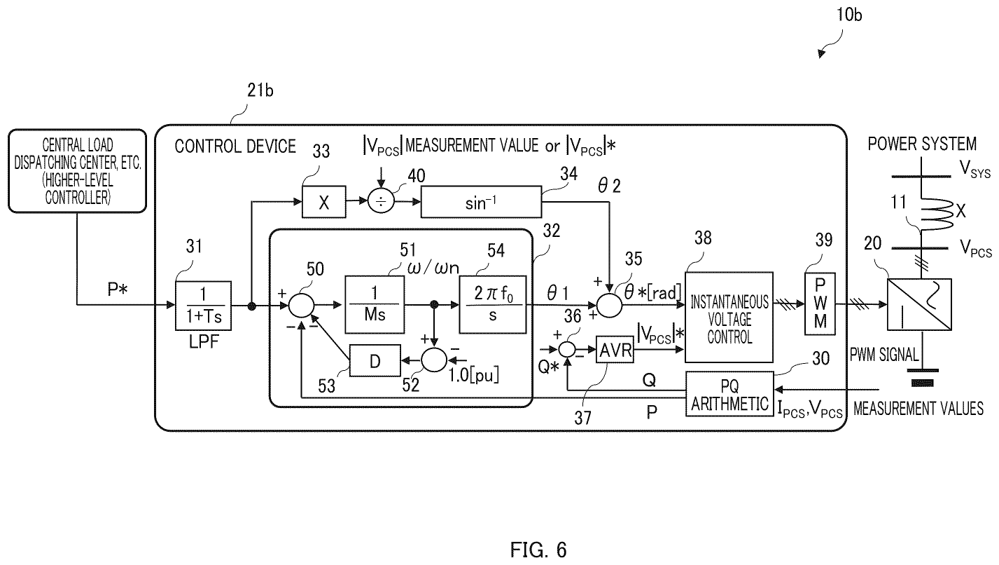

FIG. 6 is a diagram illustrating an example of the power converter 10b of an embodiment of the present disclosure. The power converter 10b includes the inverter 20 and a control device 21b. The control device 21b includes the PQ arithmetic unit 30, the low-pass filter (LPF) 31, the virtual synchronous power generation unit 32, the multiplication unit 33, the arithmetic unit 34, the addition units 35, 36, the automatic voltage regulator (AVR) 37, the instantaneous voltage control unit 38, the PWM circuit 39, and a division unit 40.

When the control device 21b and the control device 21a are compared, they are the same except for the division unit 40, and thus the division unit 40 will be described. Here, in Expression (1), when it is assumed that |VSYS| out of |VPCS| and |VSYS| is the rated value of 1.0 [pu], Expression (1) results in Expression (4).

$$Δ θ = sin - 1 ( P \cdot X / \vert VPCS \vert ) \qquad ( 4 )$$

The division unit 40 is, together with the multiplication unit 33 and the arithmetic unit 34, a functional block to implement Expression (4), and divides the output from the multiplication unit 33 by |VPCS|. In an embodiment of the present disclosure, the amplitude of the output voltage VPCS includes a measurement value at the position A measured by the PQ arithmetic unit 30 (i.e., the measured value of |VPCS|) and a calculated value outputted from the AVR 37 (i.e., |VPCS*|).

The division unit 40 of an embodiment of the present disclosure calculates P·X/|VPCS| of Expression (4) using the measurement value at the position A (i.e., the measured value of |VPCS|), but it is not limited thereto. For example, the division unit 40 may use the calculated value (i.e., |VPCS*|) outputted from the AVR 37 to calculate P·X/|VPCS| of Expression (4).

Even when the control device 21b including the division unit 40 as such is used, the phase θ2 of the output voltage VPCS for causing the active power P to be the command value P* can be outputted through a feedforward path (path from the multiplication unit 33 through the division unit 40 to the arithmetic unit 34). As a result, as in the power converter 10a, when the command value P* of the active power P changes, the power converter 10b can immediately cause the active power P to be the command value P* while suppressing the power oscillations of each of the active power P and the reactive power Q.

### Other

In the control device 21b of the power converter 10b in FIG. 6, the division unit 40 causes |VSYS|, out of |VPCS| and |VSYS|, to be the rating of 1.0 [pu], but it is not limited thereto. The division unit 40 may also obtain an actually measured value of |VSYS| from, for example, the load dispatching center, and calculate P·X/(|VPCS|·| VSYS|). As such, even if P·X is divided by the product of the amplitude of the output voltage VPCS and the amplitude of the system voltage VSYS, the phase θ2 of the output voltage VPCS can be outputted through the feedforward path and thus the same effect as in the power converter 10a of an embodiment of the present disclosure can be obtained

### SUMMARY

The above describes the power converters 10a, 10b of an embodiment of the present disclosure. For example, as illustrated in FIGS. 4 and 5, when the command value P* of the active power P changes, the power converter 10a can immediately causes the active power P to be the command value P* while suppressing the power oscillations of each of the active power P and the reactive power Q. Accordingly, the use of the power converter 10a as such can prevent a step-out.

Further, as illustrated in the power converter 10b in FIG. 6, the control device 21b may include the division unit 40. Even in such a case, the control device 21b outputs the phase θ2 through the feedforward path, and thus power fluctuations can be suppressed.

Further, the division unit 40 of the power converter 10b may use the measurement value of the output voltage VPCS at the position A (i.e., the measured value of |VPCS|). In such a case, it is possible to output the phase θ2 that is more accurate to cause the active power P to be the command value P*.

Further, the division unit 40 of the power converter 10b may use the calculated value (i.e., |VPCS*|) outputted from the AVR 37.

Further, the division unit 40 of the power converter 10b may divide the output of the multiplication unit 33 using the product of the amplitude of the output voltage VPCS and the amplitude of the system voltage VSYS. In such a case, it is possible to output the phase θ2 that is more accurate to cause the active power P to be the command value P*.

The present disclosure is directed to provision of a control device and a power converter capable of suppressing power fluctuations of an inverter.

According to the present disclosure, it is possible to provide a control device and a power converter capable of suppressing power fluctuations of an inverter.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

What is claimed is:

1. A control device having a virtual synchronous generator function, the control device being configured to control an inverter interconnected to a power system via a power transmission/distribution line, the control device comprising:
a first output unit configured to
receive a first command value, and active power from the inverter, and
output a first phase of an output voltage of the inverter based on the active power, the first command value, and the virtual synchronous generator function;
a second output unit configured to
receive a second command value, and reactive power from the inverter, and
output an amplitude of the output voltage based on the reactive power and the second command value;
a phase correction value output unit configured to
receive the first command value, and
output a phase correction value, based on the first command value and a circuit constant of the power transmission/distribution line between the inverter and the power system;
an addition unit configured to output a second phase obtained by adding the phase correction value and the first phase; and
a third output unit configured to output a control signal to control the inverter, based on the amplitude of the output voltage and the second phase.

2. The control device according to claim 1, wherein
the phase correction value output unit includes
a multiplication unit configured to multiply the first command value by the circuit constant, to thereby generate a multiplication result, and
an arithmetic unit configured to calculate an arcsine value of the multiplication result, to thereby output the arcsine value as the phase correction value.

3. The control device according to claim 1, wherein:
the phase correction value output unit includes
a multiplication unit configured to multiply the first command value by the circuit constant, to thereby generate a multiplication result,
a division unit configured to divide the multiplication result by another amplitude of the output voltage, to thereby generate a division result, and
an arithmetic unit configured to calculate an arcsine value of the division result, to thereby output the arcsine value as the phase correction value.

4. The control device according to claim 3, wherein said another amplitude of the output voltage is a measured amplitude of the output voltage.

5. The control device according to claim 3, wherein said another amplitude of the output voltage is the amplitude of the output voltage outputted by the second output unit.

6. The control device according to claim 3, wherein the division unit divides the multiplication result by a product of said another amplitude of the output voltage and an amplitude of a system voltage of the power system, to thereby generate the division result.

7. A power converter comprising:
an inverter interconnected to a power system via a power transmission/distribution line; and
a control device having a virtual synchronous generator function, the control device being configured to control the inverter, the control device including
a first output unit configured to
receive a first command value, and active power from the inverter, and
output a first phase of an output voltage of the inverter based on the active power, the first command value, and the virtual synchronous generator function,
a second output unit configured to
receive a second command value, and reactive power from the inverter, and
output an amplitude of the output voltage based on the reactive power and the second command value,
a phase correction value output unit configured to
receive the first command value, and
output a phase correction value, based on the first command value and a circuit constant of the power transmission/distribution line between the inverter and the power system,
an addition unit configured to output a second phase obtained by adding the phase correction value and the first phase, and
a third output unit configured to output a control signal to control the inverter, based on the amplitude of the output voltage and the second phase.
